(19) United States
(12) Patent Application Publication
(10) Pub. No.: US 2012/0209982 A1
(43) Pub. Date: Aug. 16, 2012

(54) NETWORK DEVICE MATCHING

(75) Inventors: John Elliott, Lake Forest Park, WA (US); Don Gillett, Bellevue, WA (US); Arnold N. Blinn, Hunts Point, WA (US)

(73) Assignee: MICROSOFT CORPORATION, Redmond, WA (US)

(21) Appl. No.: 13/024,987

(22) Filed: Feb. 10, 2011

(51) Int. Cl. G06F 15/173

(52) U.S. Cl. 709/224

(57) ABSTRACT

Various embodiments are disclosed that relate to matching network devices on a computing device. For example, one disclosed embodiment provides a method of operating a computing device. The method includes receiving a match request from a first client device, finding a second client device based on one or more constraints, if a second client device is found, sending the match request to the second client device, and if a second client device is not found based on the one or more constraints, relaxing the one or more constraints until a second client device is found and sending the match request to the second client device.

### BACKGROUND

Computing devices may connect to one another over various networks to exchange data. For example, two users of applications on different mobile devices such as cell phones or portable digital assistants (PDAs), may be matched for the exchange of data or to interact with each other via various negotiation schemes such as a trading of pass codes, creation of lobbies, or an establishment of information retrieval or Bluetooth sessions. Connected or matched devices may interact with each other via various applications running on the devices,

### SUMMARY

Various embodiments are disclosed that relate to matching network devices in a computing device. For example, one disclosed embodiment provides a method of operating a computing device comprising receiving a match request from a first client device, finding a second client device based on one or more constraints, if a second client device is found, sending the match request, to the second client device, and if a second client, device is not found based on the one or more constraints, relaxing the one or more constraints until a second client device is found and sending the match request to the second client device.

This Summary is provided, to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a computing system in accordance with the disclosure.

FIG. 2 shows an embodiment of a method of matching network devices.

FIG. 3 shows a block diagram depicting an embodiment of a computing device.

### DETAILED DESCRIPTION

As mentioned above, users of computing devices may wish to connect applications on these devices to one another over various networks to exchange data. Complex negotiations may be performed to pair users of computing devices on a network for an application, e.g., a partner to interact with, an opponent in a game, or someone to trade data with. For example, users may be matched over a network via various negotiation schemes such as a trading of pass codes, creation of lobbies (a name plus optional password lookup), or an establishment of information retrieval or Bluetooth sessions. However, such negotiation schemes may take time and may be complex and confusing to a user. As a result, these applications may be less used.

In view of the above, embodiments of matching network devices are disclosed herein, in which various constraints are used to match users. Further, such constraints may be relaxed until a suitable match is found.

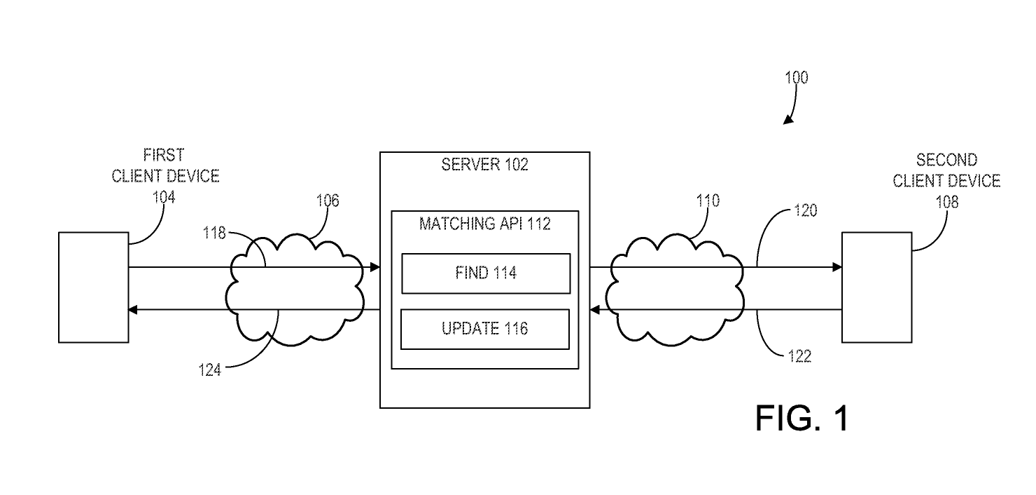

An embodiment of a computing system 100 in accordance with the disclosure is shown in FIG. 1. Computing system 100 includes a server 102 including a matching application programming interface (API) 112 configured to match client devices, e.g., first client device 104 and second client device 108, via one or more networks such as network 106 and network 110 which may be the same network or different networks. If devices are paired, server 102 may act as a communication channel. (relay) between the devices to trade information.

The matching API includes a find function 114 configured to, in response to a call 118 from first client device 104, find a second client device, e.g., second client device 108. Thus, call 118 may be a match request specifying that a user of first client device 104 wishes to pair with a user of another client device. The call may include device information such as global positioning system (GPS) location data, mobile operator, manufacturer, user credentials, operating system, application, device configuration settings, etc. In some examples, find function 114 may find a plurality of client devices and return a list of matches to the first client device so that a user of the device may choose a match from the list or interact with multiple devices.

Various factors or constraints may be used by server 102 to find a partner computer in response to receiving a match request from first client device 104. In some examples, these constraints may be communicated to server 102 by first client device 104 and used to find one or more other client devices based on the constraints. Further, in some examples, if a matching device is not found, one or more of the constraints may be relaxed until a matching device is found. This relaxation may be performed automatically on the server, or may be controlled by the client subsequently deciding and communicating this to the server. In other embodiments, one or more constraints may be stored at the server, rather than sent by the client device.

Examples of constraints that call 118 may send to find function 114 include, but are not limited to, a desired match, application and/or data type identifiers, credentials of the end user making the call, time tolerances (e.g., wait times), tolerance decay (how tolerance is to be relaxed over time if the server is holding the response), latitude/longitude, distance tolerance, distance tolerance decay, pass codes (this allows both clients to enter a specific pass code for a match), spatial coordinates (e.g., three-dimensional vectors accounting for positioning of the client device such as device tilt), spatial distance tolerance and decay, byte data (data to send the other client), and flags indicating if the server should wait for a match to return, e.g., indicating that a passcode has been accepted by a match.

If a second client device is found by the matching API, server 102 sends a matching request via a call 120 to the second client device 108 and find function 114 returns, via call 124, a suitable return may include an identifier (e.g., a GUN and/or data from a paired client, which may be null if no match is found. In some examples, if not device is found, the server may wait to respond to the client with a match or may return a null indicating no match.

In some embodiments, the additional exchange of data between two paired client devices may be handled by an update function 116 on server 102. For example, call 122 from second client device 108 may be received by the update function 116 on server 102 to update data on the server side. The update data may then be sent by the server to first client device 104 via call 124. In this way, server 102 acts as a communication channel (relay) between the devices to trade data between first client device 104 and second client device 108. In some examples, data may be traded when a match is made. The update function on server 102 allows for subsequent trading of data and performing update counts, or not sharing the data until confirmation has been received from a matched device.

Matching API 112 may also be configured to handle termination of a matching session, e.g., in response to receiving a termination call from a client device. Further, in some examples, a matching session may be timed out after a time threshold. For example, a matching session may be a short-lived session which times out after five seconds, or may be a long⁻lived session which may remain active indefinitely or until a client, device sends a termination call. Such time-thresholds may be dependent on an application used by the client devices,

Further, in some embodiments, matching API may have pre-match time-out settings, e.g., an amount of time to keep a potential match before giving up, and post-match time-out settings, e.g., an amount of time to keep a match once it is made. Such settings may be stored on server 102 and/or set by a client, device making a call to server 102.

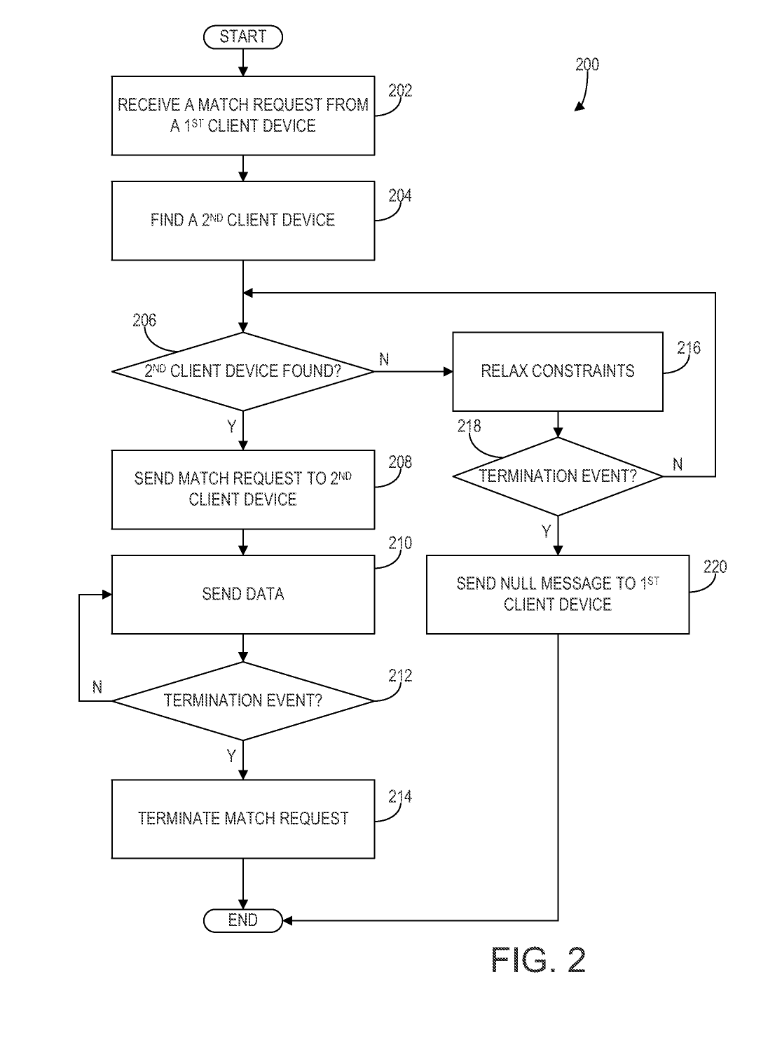

Turning now to FIG. 2, an embodiment of a method 200 of matching network devices on a computing device, e.g., server 102, is shown. At 202, method 200 includes receiving a match request from a first client device, e.g., via a call from a client, device to matching API 112. As remarked above, the match request may include information such as GPS data, a locale of the device, mobile operator of the device, manufacturer of the device, user credentials of a user of the device, operating system of the device, applications running on the device, and other device configuration settings.

At 204, method 200 includes finding a second client device based on one or more constraints. As remarked above, the one or more constraints may include one or more of application constraints, user credentials, a time tolerance, a time tolerance decay, a distance tolerance, a distance tolerance decay, and a pass code.

At 206, method 200 includes determining if a second client device is found. If a second client device is found at 206, method 200 proceeds to 208.

At 208, method 200 includes sending the match request to the second client device. For example, server 102 may send the match request to the second client device in response to the request from the first client device. At 210, method 200 includes sending data. For example, an identifier may be sent to the first and second client device and update data may be received from the second client device and then sent to the first client device.

At 212, method 200 includes determining if a termination event occurs. For example, a user of a client device may send a termination request to server 102 to terminate a matching session. As another example, a time-out may be reached at which point the matching session is automatically terminated. In still, another example, an application running on a client device may terminate the matching session., e.g., in response to a completion of an application function.

If a termination event does not occur at 212, method 200 returns to 210 to continue sending data. However, if a termination event occurs at 212, then method 200 comprises terminating the match request at 214. As remarked above, a match request may be terminated in response to input by a user of the first client, device or a user of the second client device or if a second client device is not found after a time threshold.

Returning to 206, if a second client device is not found at 206, then method 200 proceeds to 216. At 216, method 200 includes relaxing one or more constraints until a second client device is found.

The constraints may be relaxed in any suitable manner. For example, in some embodiments, decay functions on the client devices and/or the server may be used to relax one or more of the constraints. As a specific example, a constraint may be relaxed over time using a decay function from a first value to a second value, third value, etc., until a match is found. Thus, if one of the constraints is distance, the distance constraint may be increased over time until a match is found based on the distance.

At 218, method 200 includes determining if a termination event occurs. For example, a user of the first client device may send a termination request to server 102 to terminate a matching request. As another example, a time-out may be reached at which point the matching request expires and the request is automatically terminated. In still, another example, an application running on the first client device may terminate the matching request if a match has not been found in a suitable time frame. As still another example, one or more constraints may only be relaxed to a maximum permitted. In this example, a match request may be terminated if one or more of the constraints are relaxed to a maximum permitted amount.

If a termination event does not occur at 218, the method 200 returns to 206 to determine if a second client, device is found after the constraints have been relaxed.

However, if at 218, a termination event is detected, then method 200 proceeds to 220. At 220, method 200 includes sending a null message to the first client device indicating that a match has not been found. In some examples, if a match is not found, the first device may initiate another match request based on the client relaxing constraints.

In some examples, method 200 may be used to find a plurality of client devices based on the one or more constraints, and identifiers for each of the plurality of client devices may be sent to the first client device. The plurality of found matches may be sent to the first client device in a list so that a user of the first client device may choose a match or interact with multiple client devices. Further, in some examples, such a list of matches may be sorted or prioritized based on a variety of weighting factors. For example, users at the top of the list may be users who have been previously connected with, users who are physically closest, etc.

In some embodiments, the above described methods and processes may be tied to a computing system including one or more computers. In particular, the methods and processes described herein may be implemented as a computer application, computer service, computer API, computer library, and/or other computer program product.

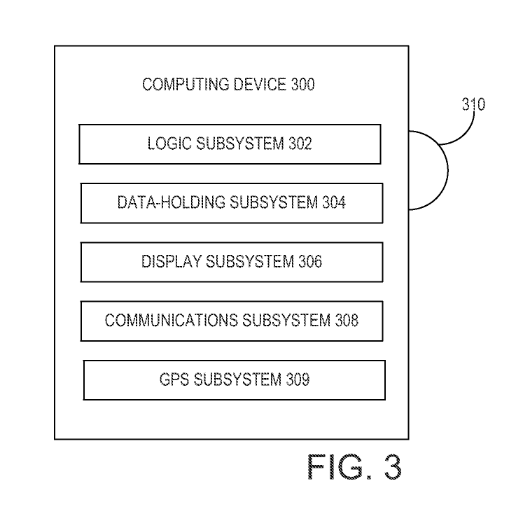

FIG. 3 schematically shows a nonlimiting computing device 300 that may perform one or more of the above described methods and processes. Computing device 300 is shown in simplified form. It is to be understood that virtually any computer architecture may be used without departing from the scope of this disclosure. In different embodiments, computing device 300 may take the form of a mainframe computer, server computer, desktop computer, laptop computer, tablet computer, home entertainment computer, network computing device, mobile computing device, mobile communication device, gaming device, etc.

Computing device 300 includes a logic subsystem 302 and a data-holding subsystem 304. Computing device 300 may optionally include a display subsystem 306, communication subsystem 308, GPS subsytem 309, and/or other components not shown in FIG. 3. Computing device 300 may also optionally include user input, devices such as keyboards, mice, game controllers, cameras, microphones, and/or touch screens, for example.

Logic subsystem 302 may include one or more physical devices configured to execute one or more machine-readable instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 304 may include one or more physical, non-transitory, devices configured to hold data and/or instructions executable by the logic subsystem to implement the herein described methods and processes. When such methods and processes are implemented, the state of data-holding subsystem. 304 may be transformed. (e.g., to hold different data),

Data-holding subsystem 304 may include removable media and/or built-in devices. Data-holding subsystem 304 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc), among others. Data-holding subsystem 304 may include devices with one or more of the following characteristics: volatile, nonvolatile, dynamic, static, read/write, read-only, random access, sequential access, location addressable, file addressable, and content addressable. In some embodiments, logic subsystem 302 and data-holding subsystem 304 may be integrated into one or more common devices, such as an application specific integrated circuit or a system on a chip.

FIG. 3 also shows an aspect of the data-holding subsystem in the form of removable computer-readable storage media 310, which may be used to store and/or transfer data and/or instructions executable to implement the herein described methods and processes. Removable computer-readable storage media 310 may take the form of CDs, DVDs, HD-DVDs, Bin-Ray Discs, EEPROMs, and/or floppy disks, among others.

It is to be appreciated that a “service”, as used herein, may be an application program executable across multiple user sessions and available to one or more system components, programs, and/or other services. In some implementations, a service may run on a server responsive to a request from a client.

When included, display subsystem 306 may be used to present a visual, representation of data held by data-holding subsystem 304. As the herein described methods and processes change the data held by the data-holding subsystem, and thus transform the state of the data-holding subsystem, the state of display subsystem 306 may likewise be transformed to visually represent changes in the underlying data. Display subsystem 306 may include one or more display devices utilizing virtually any type of technology. Such display devices may be combined with logic subsystem 302 and/or data-holding subsystem 304 in a shared enclosure, or such display devices may be peripheral display devices.

When included, communication subsystem 308 may be configured to communicatively couple computing device 300 with one or more other computing devices. Communication subsystem 308 may include wired and/or wireless communication devices compatible with one or more different, communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing device 300 to send and/or receive messages to and/or from other devices via a network such as the Internet.

When included, GPS subsystem 309 may be configured to identify global positioning data or other suitable location data of computing device 300 which may be transmitted via communication subsystem 308 to other computing devices or systems over a network.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of operating a computing device, comprising:
receiving a match request from a first client device;
finding a second client device based on one or more constraints;
if a second client device is found, sending the match request to the second client device; and
if a second client device is not found based on the one or more constraints, relaxing the one or more constraints until a second client device is found and sending the match request to the second client device.

2. The method of claim 1, further comprising terminating a match request in response to input by a user of the first client, device or a user of the second client device.

3. The method of claim 1, further comprising, if a second client device is not found after relaxing the constraints to a maximum permitted, sending a null message to the first client device.

4. The method of claim 1, wherein the one or more constraints includes one or more of application constraints, user credentials, a time tolerance, a time tolerance decay, a distance tolerance, a distance tolerance decay, and a pass code.

5. The method of claim 1, further comprising, if a second client device is found, sending an identifier to the first and second client devices.

6. The method of claim 1, further comprising, if a second client device is found, sending data to the second client device.

7. The method of claim 1, further comprising, if a second client device is found, receiving update data from the second client device and sending update data to the first client device,

8. The method of claim 1, further comprising, if a second client device is not found after a time threshold, terminating the match request.

9. The method of claim 1, further comprising finding a plurality of client devices based on the one or more constraints, and sending identifiers for each of the plurality of client devices to the first client device.

10. A method of operating a computing device, comprising:
receiving a match request from a first client device;
finding a second client device based on a distance constraint;
if a second client device is found, sending the match request to the second client device; and
if a second client device is not found based on the distance constraint, relaxing the distance constraint, until a second client device is found and sending the match request to the second client device.

11. The method of claim 10, wherein relaxing the distance constraint includes increasing the distance constraint, as a function of time.

12. The method of claim 10, further comprising terminating a match request in response to input by a user of the first client device or a user of the second client device.

13. The method of claim 10, further comprising, if a second client device is found, sending an identifier to the first and second client devices.

14. The method of claim 10, further comprising, if a second client device is found, sending data to the second client device, and receiving update data from the second client device and sending update data to the first client device.

15. The method of claim 10, further comprising finding a plurality of client devices based on the distance constraint, and sending identifiers for each of the plurality of client devices to the first client device.

16. A computing device, comprising:
a logic subsystem; and
a data holding subsystem comprising machine-readable instructions stored thereon that are executable by the logic subsystem to:
receive a match request from a first client device;
find a second client device based on one or more constraints;
if a second client, device is found, send the match request to the second client device; and
if a second client device is not found based on the one or more constraints, relax the one or more constraints until a second client device is found and send the match request to the second client device.

17. The computing device of claim 16, wherein the data holding subsystem comprising machine⁻readable instructions stored thereon that are executable by the logic subsystem is further configured to: if a second client device is not found after relaxing the constraints to a maximum permitted, send a null message to the first client, device.

18. The computing device of claim 16, wherein the data holding subsystem comprising machine-readable instructions stored thereon that are executable by the logic subsystem is further configured to: if a second client device is found, send data to the second client device.

19. The computing device of claim 16, wherein the data holding subsystem comprising machine-readable instructions stored thereon that are executable by the logic subsystem is further configured to: if a second client, device is not found after a time threshold, terminate the match request.

20. The computing device of claim 16, wherein the data holding subsystem comprising machine-readable instructions stored thereon that are executable by the logic subsystem is further configured to: find a plurality of client devices based on the one or more constraints, and send identifiers for each of the plurality of client devices to the first client device.
